(19) United States
(12) Patent Application Publication
(10) Pub. No.: US 2013/0138523 A1
(43) Pub. Date: May 30, 2013

(54) INFORMATION PROCESSING APPARATUS, INFORMATION PROCESSING METHOD, AND PROGRAM

(71) Applicant: Sony Corporation, Tokyo (JP)

(72) Inventors: Naoto TSUBOI, Kanagawa (JP); Takehiro HAGIWARA, Tokyo (JP); Naoki KAMIMAEDA, Kanagawa (JP); Tomohiro TSUNODA, Tokyo (JP); Shinako MATSUYAMA, Tokyo (JP); Takuya ISHIOKA, Tokyo (JP); Naoya SAZUKA, Tokyo (JP); Yasunori OHTO, Kanagawa (JP)

(73) Assignee: SONY CORPORATION, Tokyo (JP)

(21) Appl. No.: 13/677,655

(22) Filed: Nov. 15, 2012

(30) Foreign Application Priority Data
Nov. 29, 2011 (JP) 2011260433

(51) Int. Cl. G06Q 30/06

(52) U.S. Cl. CPC G06Q 30/0601
USPC 705/26.1

(57) ABSTRACT

There is provided an information processing apparatus including a condition acquisition unit that acquires a task condition of a shopping task, a cost calculation unit that calculates a cost of a candidate of a purchase behavior for executing the shopping task by a participating member participating in the shopping task based on a characteristic of an item purchased through the purchase behavior, and a determination unit that determines the purchase behavior of the participating member based on the cost.

### BACKGROUND

The present disclosure relates to an information processing apparatus, an information processing method, and a program.

Shopping for commodities is an everyday task and there is a high desire to execute it efficiently. Accordingly, for example, Japanese Unexamined Patent

Application Publication No. 2005-259024 discloses a shopping support system that determines kinds and amounts of cooking ingredients to be purchased based on menu information and notifies terminal apparatuses of the kinds and amounts of cooking ingredients. Further, Japanese Unexamined Patent Application Publication No. 2002-117221 discloses a system that requests a person to do shopping. When a shopping support server requests a person to do shopping, the shopping support server is able to transmit not only information on a product desired to be purchased but also additional information on a requested product to a requested person.

### SUMMARY

In order to support shopping, however, many parameters should be actually considered. Therefore, it is difficult to construct a system that provides shopping support that is actually useful. In particular, many parameters should be considered in order to plan shopping.

It is desirable to provide a support, system that plans shopping more efficiently.

According to an embodiment of the present disclosure, there is provided an information processing apparatus including a condition acquisition unit that acquires a task condition of a shopping task, a cost calculation unit that calculates a cost of a candidate of a purchase behavior for executing the shopping task by a participating member participating in the shopping task based on a characteristic of an item purchased through the purchase behavior, and a determination unit that determines the purchase behavior of the participating member based on the cost.

In this configuration, the purchase behavior of the participating g member of the shopping task is determined using the cost based on the characteristic of an item to be purchased. Accordingly, for example, a shopping support system is able to be realized by digitizing an effort of the purchase behavior as a cost based on the characteristics such as a kind of an item to be purchased, the size of the item, the weight of the item, and the fact that the item is a raw stuff or not and determining the purchase behavior based on the cost. Thus, it is possible to provide the support system that plans efficient shopping.

According to another embodiment of the present disclosure, there is provided an information processing method including acquiring a task condition of a shopping task, calculating a cost of a candidate of a purchase behavior for executing the shopping task by a participating member participating in the shopping task based on a. characteristic of an item purchased through the purchase behavior, and determining the purchase behavior of the participating member based on the cost.

According to still another embodiment of the present disclosure, there is provided a program for causing a computer to function as an information processing apparatus including a condition acquisition unit that acquires a task condition of a shopping task, a cost calculation unit that calculates a cost of a candidate of a. purchase behavior for executing the shopping task by a participating member participating in the shopping task based on a characteristic of an item purchased through the purchase behavior, and a determination unit that determines the purchase behavior of the participating member based on the cost.

According to the embodiments of the present disclosure described above, it is possible to plan shopping more efficiently.

### BRIEF DESCRIPTION OF THE DRAWINGS

FIG. 1 is a diagram illustrating the configuration of a shopping support system according to an embodiment of the present disclosure;

FIG. 2 is a block diagram illustrating a functional configuration of a shopping support server according to the embodiment;

FIG. 3 is a flowchart illustrating a process of the shopping support system according to the embodiment;

FIG. 4 is a diagram illustrating an example of a task issuing screen of the shopping support system according to the embodiment;

FIG. 5 is a diagram illustrating an example of a participation possibility confirmation screen of the shopping support system according to the embodiment;

FIG. 6 is a diagram illustrating an example of a purchase behavior acceptance and confirmation screen of the shopping support system according to the embodiment;

FIG. 7 is a diagram illustrating an example of a purchase store selection screen of the shopping support system according to the embodiment;

FIG. 8 is a diagram illustrating an example of a progress status confirmation screen of the shopping support system according to the embodiment;

FIG. 9 is a flowchart illustrating a process of extracting purchase behavior candidates of the shopping support server according to the embodiment;

FIG. 10 is a diagram illustrating cost calculation of the shopping support server according to the embodiment;

FIG 11 is a table illustrating examples of parameters considered in the cost calculation of the shopping support server according to the embodiment;

FIG. 12 is a flowchart illustrating an example of a purchase behavior determination process of the shopping support server according to the embodiment;

FIG. 13 is a flowchart illustrating another example of the purchase behavior determination process of the shopping support server according to the embodiment;

FIG. 14 is a diagram illustrating the purchase behavior determination process of the shopping support server according to the embodiment;

FIG. 15 is a block diagram illustrating an example of a hardware configuration of the shopping support server according to the embodiment; and

FIG. 16 is a block diagram illustrating an example of a hardware configuration of a requester terminal and a member terminal according to the embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Description will be made in the following order.

1. Overview

2. Functional Configuration of Shopping Support Server

3. Example of Process

4. Extracting Purchase Behavior Candidates

5. Calculating Cost

6. Determining Purchase Behavior

7. Example of Hardware Configuration

1. Overview

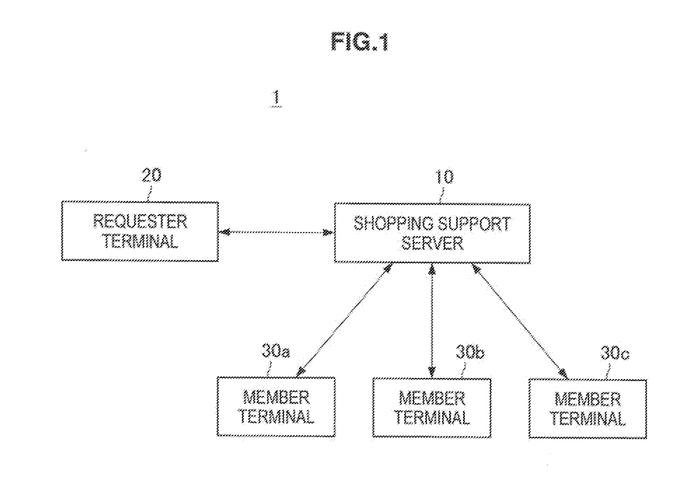

First, the overview of a shopping support system according to an embodiment of the present disclosure will be described with reference to FIG. 1. FIG. 1 is a diagram illustrating the configuration of the shopping support system according to the embodiment of the present disclosure.

As described above, shopping for commodities is an everyday tasks and there is a high desire to execute it efficiently. Accordingly, the embodiment of the present disclosure suggests a shopping support system 1 that supports efficient shopping, The shopping support system 1 has a function of planning efficient purchase behavior. Here, the shopping support system 1 is able to plan purchase behavior including information regarding a purchaser, a purchase route, a purchase store, and a purchase item. Further, the shopping support system 1 is able to support the execution of the planned purchase behavior. For example, the shopping support system 1 is able to support sharing information regarding progress of the planned purchase behavior. Furthermore, when it is difficult to execute the planned purchase behavior, the shopping support system 1 is able to support replanning of purchase behavior,

In order to plan shopping, however, many parameters should be considered. For example, to execute shopping efficiently, all of the necessary items are preferably purchased at a smaller number of stores. Further, when family members are shopping together, the family members may shop for different items. The amount of item to be carried is different depending on each shopping person. For example, an adult is preferably requested to purchase a heavy item such as rice or water. An adult is also preferably requested to purchase an item such as alcohol which children are forbidden to purchase. In some cases, a person who has product knowledge of a specific item is requested to purchase the specific item. With regard to a purchase store, for example, a request may be made to purchase an item preferentially at a store at which a loyalty card is able to be used.

Accordingly, the shopping support system 1 converts various parameters to be considered into numerical values known as costs. Then, the shopping support system 1 is able to support planning of the shopping based on these costs.

Referring to FIG. 1, the shopping support system 1 mainly includes a shopping support sever 10, a requester terminal 20 which is a terminal apparatus of a requester issuing a shopping task, and a member terminal 30 which is a terminal apparatus of a member receiving the request of the shopping task. At this time, the plurality of member terminals 30 may be present. Further, the requester may be a requester and a member receiving the request of the shopping task. In this case, in effect, the requester terminal 20 can also have the function of the member terminal 30.

For example, the requester terminal 20 and the member terminal 30 may be an information processing apparatus such as a cellular phone including a smart phone, a personal handyphone system (PHS), a portable music reproduction apparatus, a portable video processing apparatus, or a portable game apparatus. Further, the requester terminal 20 and the member terminal 30 may be an information processing apparatus such as a personal computer (PC), a household video processing apparatus (such as a DVD recorder or a video recorder), a personal digital assistant (PDA), a household game apparatus, or a home appliance apparatus. When the member terminal 30 is a portable information processing apparatus, the member terminal 30 is able to immediately update a progress status suitably during the execution of a shopping task.

The requester terminal 20 has a function of issuing a shopping task. The shopping task issued here is able to include designation of a requesting person, an item desired to be purchased, and information regarding a condition of the item desired o be purchased. The requester terminal 20 is able to transmit information regarding a shopping task to be issued to the shopping support server 10.

Based on the information regarding the shopping task, the shopping support server 10 is able to confirm whether a requested member participates in the shopping task. Then, based on the information regarding the member participating in the shopping task, the shopping support server 10 is able to plan a purchase behavior based on the information regarding the shopping task. The shopping support server 10 is able to recommend, to each participating member, a purchase behavior indicating which item the member purchases and at which store the member purchases an item. At this time, the shopping support server 10 is able to calculate a cost of the purchase behavior of each participating member and determine the purchase behavior based on the calculated costs.

The member terminal 30 is a terminal apparatus of a member receiving the request of the shopping task. When the member terminal 30 receives a participation request to participate in the shopping task from the shopping support server 10, the member terminal 30 is able to transmit a response indicating whether the member terminal 30 participates in the shopping task.

2. Functional Configuration of Shopping Support Server

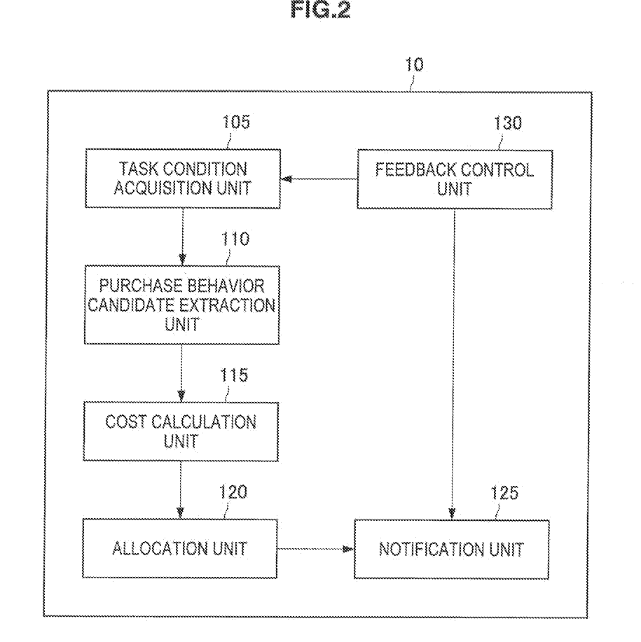

Next, the functional configuration of the shopping support server 10 according to the embodiment will be described with reference to FIG. 2. FIG. 2 is a block diagram illustrating the functional configuration of the shopping support server according to the embodiment.

Shopping Support Sever 10

Referring to FIG. 2, the shopping support server 10 mainly includes a task condition acquisition unit 105, a purchase behavior candidate extraction unit 110, a cost calculation unit 115, an allocation unit 120, a notification unit 125, and a feedback control unit 130.

Task Condition Acquisition Unit 105

The task condition acquisition unit 105 has a function of acquiring a. task condition of the issued shopping task. The task condition acquisition unit 105 is able to acquire the task condition when the task condition acquisition unit 105 receives a condition of the shopping task input by the requester from the requester terminal 20.

The task condition acquisition unit 105 is able to confirm whether or not the member terminal 30 owned by a member requesting the shopping task issued by the requester terminal 20 participates in the shopping task. The task condition acquisition unit 105 can generate a response screen on which a member requested to execute the shopping task can respond to whether or not the member can participate in the shopping task, for example, by executing a simple operation such as an operation of pressing down a button, and can supply the generated response screen to each member. The task condition acquisition unit 105 can acquire, as a task condition, information regarding the participating member who participates in the shopping task based on the response input on the response screen. The task condition acquisition unit 105 can supply the acquired task condition to the purchase behavior candidate extraction unit 110.

Purchase Behavior Candidate Extraction Unit 110

The purchase behavior candidate extraction unit 110 has a function of extracting candidates of the purchase behavior. Here, the purchase behavior may be specified by a movement route of a specific participating member, a purchase store, or an item to be purchased. For example, the purchase behavior candidate extraction unit 110 can first acquire a route used for a specific participating member to reach a destination. For example, when the participating member is located at a corporation, the purchase behavior candidate extraction unit 110 can acquire a route for returning from the corporation to his or her home. At this time, for example, a spot via a route to the destination may he designated. When the route is acquired, a behavior model learned from normal behavior may be used. Further, when the route is acquired, a route may be estimated together with a schedule management application of the participating member.

When the purchase behavior candidate extraction unit 110 extracts the candidates of the acquired movement route for each participating member, the purchase behavior candidate extraction unit 110 extracts information regarding a grid through which each route passes. Here, the purchase behavior candidate extraction unit 110 may also extract a grid adjacent to the grid through which the route passes. Various ranges of the extracted grid may be set. Accordingly, the purchase behavior candidate extraction unit 110 can extract a user ID of the participating member, a route ID of the extracted route, and a grid ID of the grid near the route. Further, the purchase behavior candidate extraction unit 110 can extract information regarding a store included in the extracted grid ID. Here, the extracted store is a candidate of a store at which the participating member purchases an item. The purchase behavior candidate extraction unit 110 acquires information regarding an item purchasable at the extracted store among purchase items included in the task condition of the shopping task.

The purchase behavior candidate extraction unit 110 can supply, to the cost calculation unit 115, information regarding a purchase behavior candidate for which the user ID, the route ID, a store ID (here, a plurality of user IDs, route IDs, and store IDs are possible), and purchase possibility information of each item are associated with each other. The purchase behavior candidate extraction unit 110 can extract the purchase behavior candidate for each member and each conceivable movement route.

Cost Calculation Unit 115

The cost calculation unit 115 has a function of calculating the cost of each purchase behavior candidate extracted by the purchase behavior candidate extraction unit 110. The purchase behavior candidate extracted by the purchase behavior candidate extraction unit 110 includes purchase possibility information of each item in the purchase behavior, but it is not yet determined whether or not each item is actually purchased with the purchase behavior. Accordingly, the cost calculation unit 115 calculates the cost of the purchase behavior candidate extracted by the purchase behavior candidate extraction unit 110. Then, the cost calculation unit 115 can supply the value of the cost of the purchase behavior candidate to the allocation unit 120. Further, when the allocation unit 120 allocates an item to be purchased to each purchase behavior candidate, the cost calculation unit 115 can add the value of the cost obtained by purchasing the item to the value of the cost of the purchase behavior candidate. The cost calculation unit 115 can supply, to the allocation unit 120, information regarding the cost of the purchase behavior candidate to which the value of the cost obtained by purchasing the item is added.

For example, the cost of the purchase behavior may be a value obtained by digitizing a time and an effort unnecessarily taken compared to an estimated route when the member does not participate in the shopping task. For example, the cost of the purchase behavior may be calculated based on the closeness of a purchase store from a station, a transfer effort (whether or not stairs have to be used), a travel cost, weather, user preference, or the like. For example, when the route is out of an area of a commuter pass, the cost of the purchase behavior may be set to be higher. For example, when the weather is bad, the cost may be set to be larger for a route in which a walk time is long. Further, the cost of the purchase behavior may be calculated in accordance with the characteristics of a participating member. Furthermore, the value of cost occurring when an item is purchased may be added to the cost of the purchase behavior. The value of the cost occurring when an item is purchased may be a specific value determined, for example, based on the characteristics of the item. For example, examples of the characteristics of an item to be considered here include the kind of an item, the size of the item, the weight of the item, the fact of whether the item is raw or not, the fact of whether the item can be transported upside down or not, and the fact of whether the item is fragile or not. Even in this case, the cost of the purchase behavior may be calculated in accordance h the characteristics of a participating member. Examples of the characteristics of a participating member to be considered include a sex, an age, and preferences (aptitude). For example, when a participating member is a child, an influence of the weight of an item on the cost may be set to be large. When a participating member has a lot of knowledge of an item to be purchased, the cost occurring when the participating member purchases the item may be calculated so as to be small.

The cost calculation unit 115 is able to calculate the cost by weighting and adding the value of the cost for various parameters that have an influence on the cost of the purchase behavior. The degree of the weighting may be different depending on, for example, each member, The degree of the weighting may be different depending on, for example, each parameter.

Allocation Unit 120

The allocation unit 120 has a function of allocating items to be purchased to the participating members based on the values of the costs calculated by the cost calculation unit 115. The allocation unit 120 is an example of a determination unit that determines the purchase behavior of each participating member by allocating the items to be purchased to the participating members. When the allocation unit 120 allocates the items for the purchase behavior candidates, the allocation unit 120 can supply information regarding the allocated items to the cost calculation unit 115. The allocation unit 120 can also allocate the item based on the cost of the purchase behavior candidate to which the value of the cost of the allocated item is added.

The allocation unit allocates the items to the participating members by allocating all of the items to be purchased to the participating members. The allocation unit 120 allocates the items such that the cost of the purchase behavior of each participating member does not exceed the allowable value of the cost. At this time, the allocation unit 120 preferably allocates the items such that, the sum of the costs of the purchase behavior of all the members is the minimum. Further, the allocation unit 120 preferably allocates the items such that a score for the allowable value of the cost of each participating member increases. Furthermore, the allocation unit 120 preferably allocates the items such that a difference in a ratio between the allowable value of the cost and the cost of the purchase behavior decreases between the members (that is, a sense of inequality decreases between the members). Accordingly, the allocation unit 120 can determine the purchase behavior of each participating member in consideration of the various components.

Notification Unit 125

The notification unit 125 has a. function of notifying the member requested to execute the shopping task of various kinds of information. The notification unit 125 can notify the member of information by providing a display screen on which information desired to be noted is displayed to the member terminal 30. For example, the notification unit 125 can notify the participating member of the purchase behavior determined by the allocation unit 120. For example, the display screen on which the notification unit 125 notifies the participating member of the purchase behavior preferably includes a feedback portion used for the participating member to respond to whether or not the participating member accepts the execution of the purchase behavior. For example, the participating member may respond to whether to accept the execution of the purchase behavior merely by pressing down any button.

Feedback Control Unit 130

The feedback control unit 130 can perform control in accordance with feedback information provided from the participating member through the display screen or the like provided by the notification unit 125. For example, the feedback control unit 130 can provide a new task condition to the task condition acquisition unit 105 so that the purchase behavior can be replanned in accordance with an increase or decrease in the participating members. When the participating member performs a behavior other than the determined purchase behavior, for example, when the participating member purchases an item other than the scheduled item or when the scheduled item is sold out and thus the participating member may not purchase the scheduled item, the feedback control unit 130 can provide a new task condition to the task condition acquisition unit 105 so that the purchase behavior is replanned.

The examples of the functions of the shopping support server 10 according to this embodiment have been described. Each constituent element described above may be configured by a general member or circuit or may be configured by hardware specialized for the function of each constituent element. Further, an arithmetic device such as a central processing unit (CPU) may execute the function of each constituent element by reading a control program describing a processing order of the functions from a storage medium such as a read-only memory (ROM) or a random access memory (RAM) that stores the control program, analyzing the control program, and executing the control program. Accordingly, the configuration to be used can be modified appropriately in accordance with a technology level when this embodiment is realized. An example of a hardware configuration of the shopping support server 10 will be described later.

A computer program for realizing the functions of the shopping support server 10 according to the above-described embodiment can be generated and installed on a personal computer or the like. Further, it is possible to provide a recording medium which stores such a computer program and from which a computer can read the computer program. Examples of the recording medium include a magnetic disk, an optical disc, a magneto-optical disc, and a flash memory. The computer program may be delivered via, for example, a network without using a recording medium.

3. Example of Process

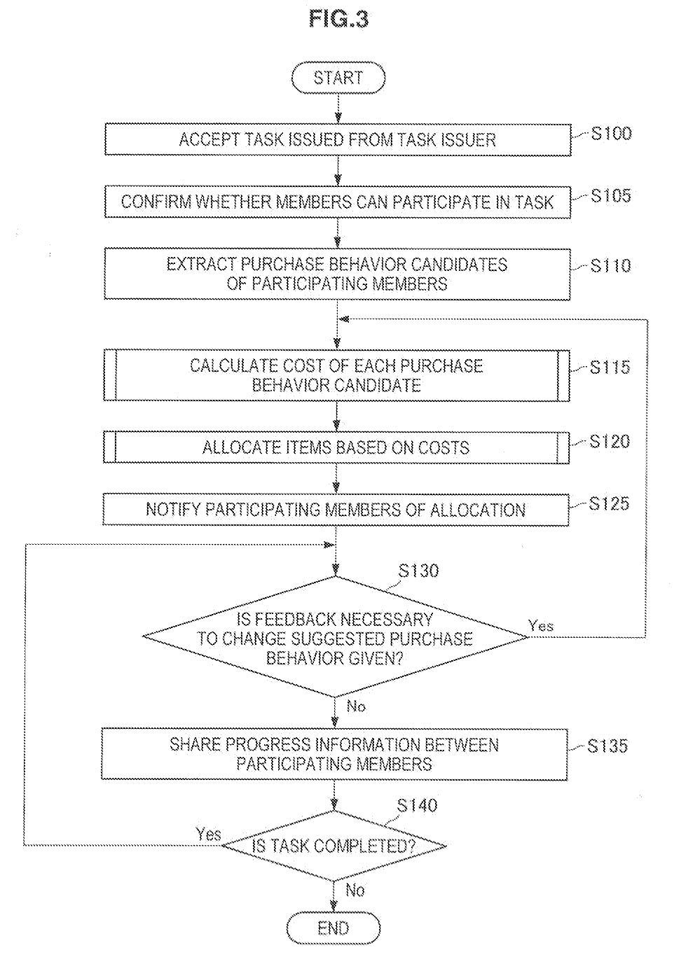

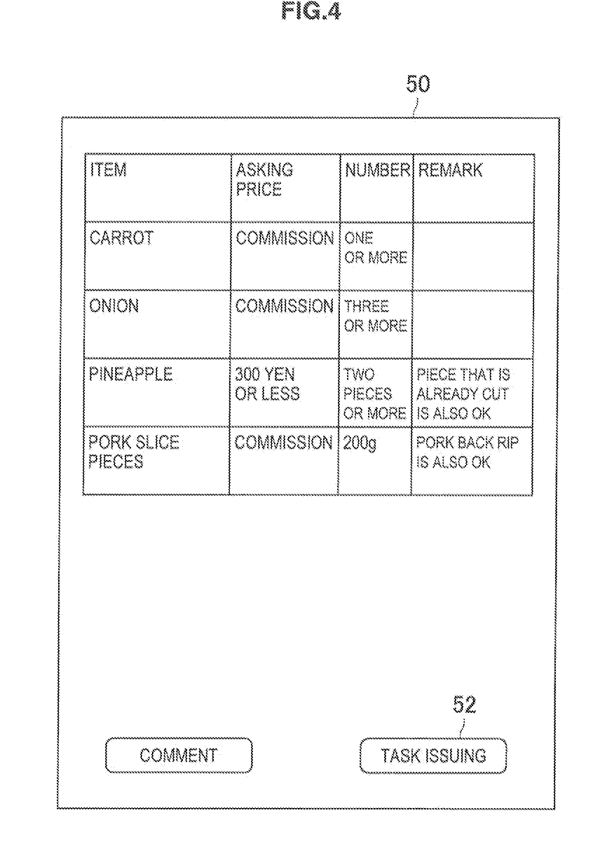

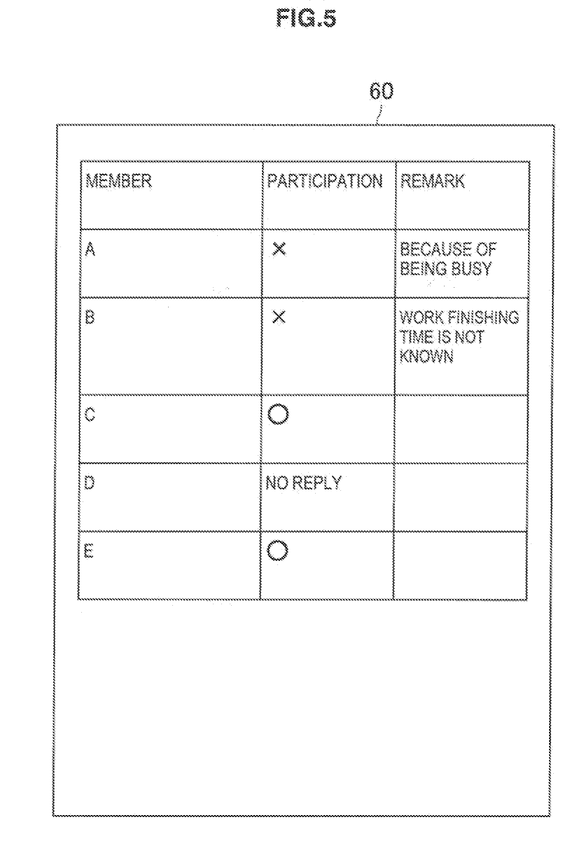

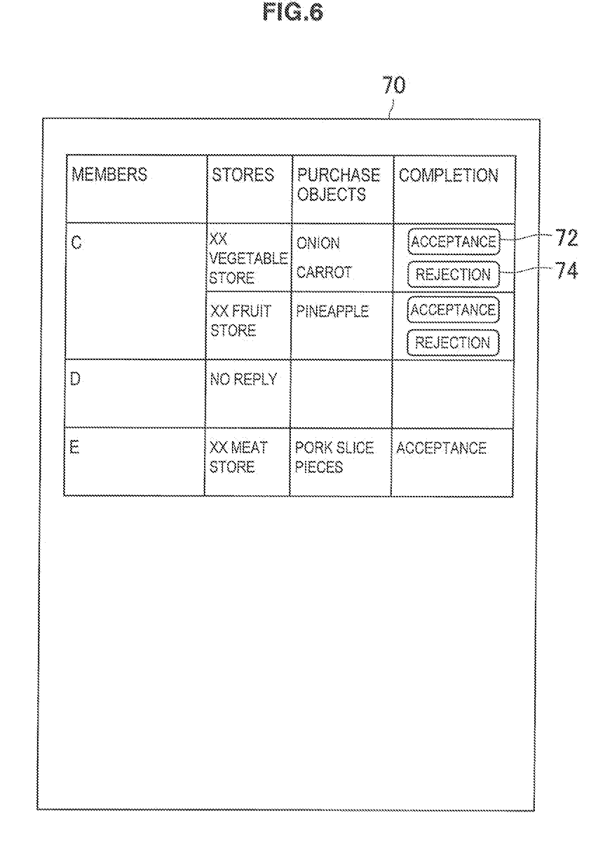

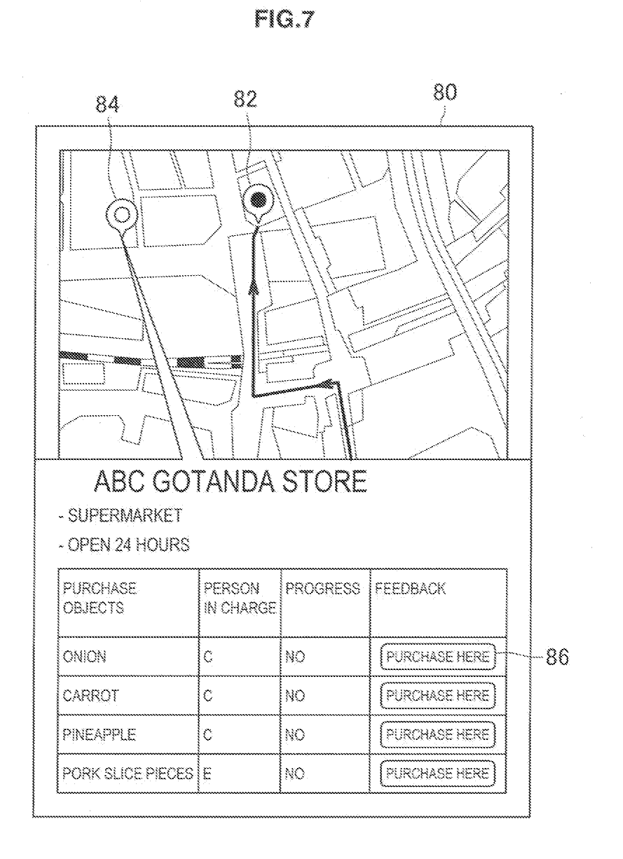

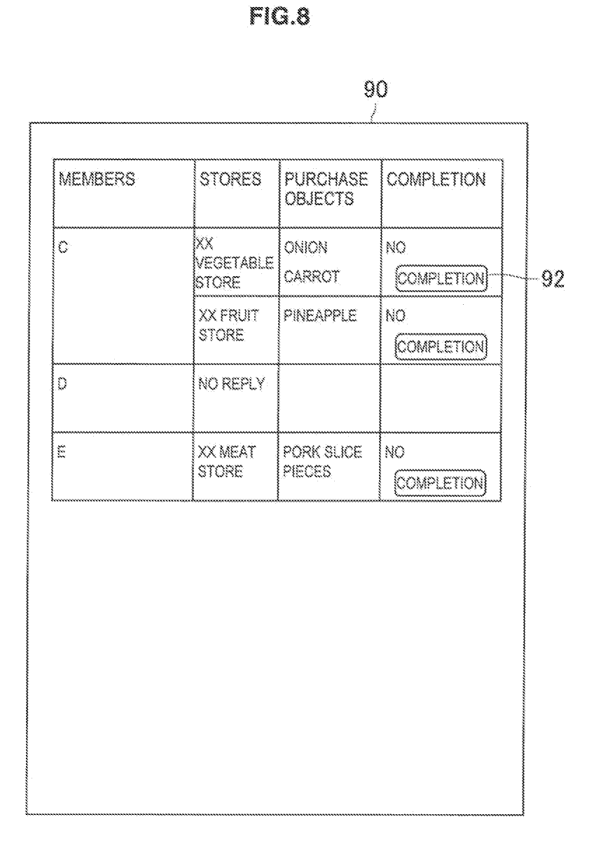

Next, an example of a process of the shopping support system 1 according to an embodiment of the present disclosure will be described with reference to FIGS. 3 to 8. FIG. 3 is a flowchart illustrating the process of the shopping support system according to the embodiment. FIG. 4 is a diagram illustrating an example of a task issuing screen of the shopping support system according to the embodiment. FIG. 5 is a. diagram illustrating an example of a participation possibility confirmation screen of the shopping support system according to the embodiment. FIG. 6 is a diagram illustrating an example of a purchase behavior acceptance and confirmation screen of the shopping support system according to the embodiment. FIG. 7 is a diagram illustrating an example of a purchase store selection screen of the shopping support system according to the embodiment. FIG. 8 is a diagram illustrating an example of a progress status confirmation screen of the shopping support system according to the embodiment.

Referring to FIG. 3, the task condition acquisition unit 105 of the shopping support server 10 accepts the issued shopping task input from the task issuer via the requester terminal 20 (S100). For example, when the requester terminal 20 inputs the task condition on a task issuing screen 50 shown in FIG. 4 and then a task issuing button 52 is pressed down, a task issuing request is transmitted to the shopping support server 10. For example, the name of a purchase item, a purchase asking price, a purchase number, and remark information corresponding to purchase can be input on the task issuing screen 50.

Referring back to FIG. 3, the task condition acquisition unit 105 confirms whether or not the member can participate in the accepted shopping task (S105). At this time, the task condition acquisition unit 105 can accept participation or non-participation by notifying, for example, a predesignated member that a task is issued. Here, the predesignated member may be a member designated via the requester terminal 20, for example, when the task is issued. Further, the predesignated member may be a member registered in association with user information in advance. A user of the shopping support system 1 may register, for example, family members in advance. The participation possibility information of the members collected by the task condition acquisition unit 105 may be provided by, for example, a participation possibility confirmation screen 60 shown in FIG. 5.

Next, referring back to FIG. 3, the purchase behavior candidate extraction unit 110 extracts the purchase behavior candidates of the participating members (S110). Then, the cost calculation unit 115 calculates the costs of the extracted purchase behavior candidates (S115). The cost calculation will be described in detail later.

Next, the purchase behavior of each participating member is determined based on the calculated costs (S125). For example, the purchase behavior is determined by causing the allocation unit 120 to allocate items to be purchased to the participating members. The allocation of the items will be described in detail later. When the purchase behaviors of the participating members are determined by causing the allocation unit 120 to allocate the items to be purchased, the notification unit 125 notifies the participating members of the determined purchase behaviors (S125).

For example, the notification may be performed through a purchase behavior acceptance and conformation screen 70 shown in FIG. 6. After the notification is performed, the participating members can provide feedback on whether to accept the execution of the suggested purchase behavior. For example, the purchase behavior acceptance and conformation screen 70 may include an acceptance button 72 used to give notification indicating the acceptance of the execution of the purchase behavior and a rejection button 74 used to give notification indicating non-execution of the purchase behavior.

The notification unit 125 may notify the participating members of a suggestion of the purchase behavior by displaying a map displaying screen on which the movement route and the purchase stores to visit indicated by the purchase behavior overlap a map. Further, when another store at which the same item can be purchased is present near the scheduled purchase store, the notification unit 125 may provide, for example, a purchase store selection screen 80 shown in FIG. 7. The position of a purchase store 82 scheduled on the map and the position of another purchase store 84 located near the purchase store 82 may be displayed on the purchase store selection screen 80. Further, a route for reaching the purchase store 82 may be also displayed. Furthermore, for example, the detailed information regarding the purchase stores 82 and 84 may be displayed on the purchase store selection screen $0. The purchase store selection screen 80 may include a purchase store selection button 86 used to select a store at which an item is purchased. For example, the purchase store selection button 86 is provided in each purchase item.

The participating member can provide feedback on the change in the purchase behavior. For example, the participating member can provide feedback on the fact that the participating member may not purchase an item included in the determined purchase behavior. Further, the participating member can provide feedback on the fact that the participating member purchases an item not included in the determined purchase behavior.

The participating member can provide feedback on a progress status of the purchase behavior. For example, feedback on a progress status may be provided on a progress status confirmation screen 90 shown in FIG. 8. The progress status confirmation screen 90 may include, for example, a completion button 92 used to provide feedback on the completion of the purchase. The participating member can provide feedback on the purchase of the item allocated to the participating member merely by pressing down the completion button 92.

Referring back to FIG. 3, the feedback control unit 130 determines whether feedback necessary to change the suggested purchase behavior is provided (S130). Examples of the feedback necessary to change the suggested purchase behavior include feedback indicating that the scheduled item may not be purchased, feedback indicating that the member is scheduled not to participate in the shopping task but participates in the shopping task, and feedback indicating that the member is scheduled to participate in the shopping task but may not participate in the shopping task. When it is determined in step S130 that the feedback necessary to change the suggested purchase behavior is provided, the process returns to step S115 to replan the purchase behavior.

Conversely, when it is determined in step S130 that the feedback necessary to change the suggested purchase behavior is not provided, a progress status is shared between the participating members (S135). Then, the feedback control unit 130 determines whether the task is completed based on the feedback on the progress status from the participating members (S140). When it is determined in step S140 that the task is not completed, the process returns to step S130 to perform the feedback control again. The feedback control is repeated until it is determined in step S140 that the task is completed.

4. Extracting Purchase Behavior Candidates

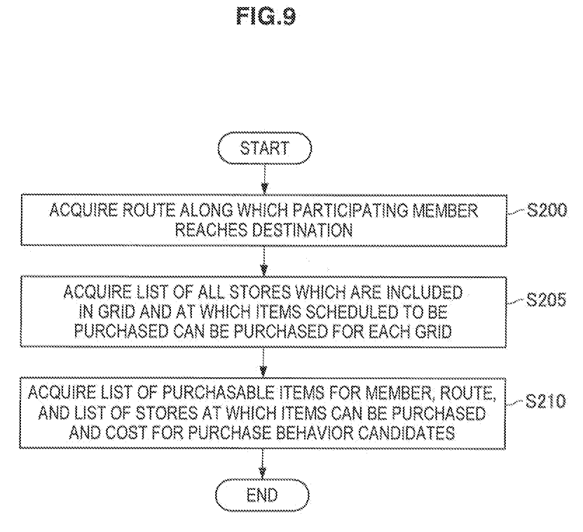

Next, a process of extracting the purchase behavior candidates by the purchase behavior candidate extraction unit 110 of the shopping support server 10 according to an embodiment of the present disclosure will be described with reference to FIG. 9. FIG. 9 is a flowchart illustrating the process of extracting the purchase behavior candidates in the shopping support server according to the embodiment.

First, the purchase behavior candidate extraction unit 110 acquires candidate routes along which the participating member reaches a destination (S200). At this time, the purchase behavior candidate extraction unit 110 can extract the plurality of candidate routes for each participating member. Further, when the candidate routes are acquired, stopovers may be designated. When the candidate routes are acquired, a behavior model learned from a normal behavior may be used. When the candidate routes are acquired, the candidate routes may be estimated in association with a schedule management application.

Although not shown here, the purchase behavior candidate extraction unit 110 may narrow down the plurality of provided candidate routes. For example, the purchase behavior candidate extraction unit 110 may narrow down the candidate routes based on feedback information or presetting from the participating member.

When the candidate route is extracted, a list of all the stores which are included in a grid and at which items scheduled to be purchased can be purchased is acquired for each grid on the candidate route (S205). Here, it is considered that the grid on the candidate route is a store searching target, but the embodiment of the present disclosure is not limited to this example. For example, a grid adjacent to the grid on the candidate route may be considered as a target.

To extract the stores at which items are purchased, the purchase behavior candidate extraction unit 110 may acquire opening time information of the stores and narrow down the stores which the participating member can actually visit, when the participating member knows a period of time in which the participating member executes the purchase behavior in advance. At this time, for example, the purchase behavior candidate extraction unit 110 may use the behavior model learned from the normal behavior to estimate the period of time in which the participating member executes the purchase behavior. Further, the purchase behavior candidate extraction unit 110 may use information regarding the schedule management application to estimate the period of time in which the participating member executes the purchase behavior.

Next, the cost calculation unit 115 calculates the cost of the extracted purchase behavior candidate (S210). Cost calculation will be described in detail below.

5. Calculating Cost

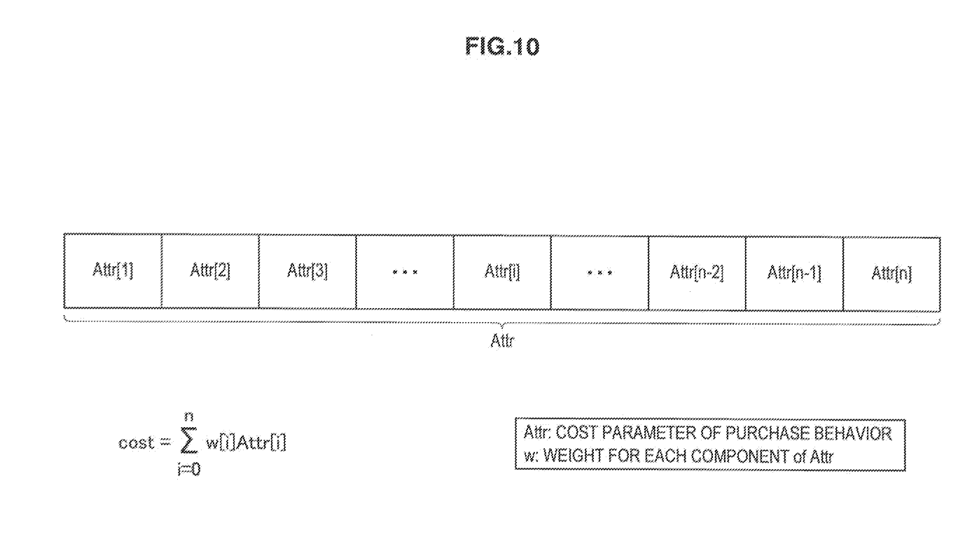

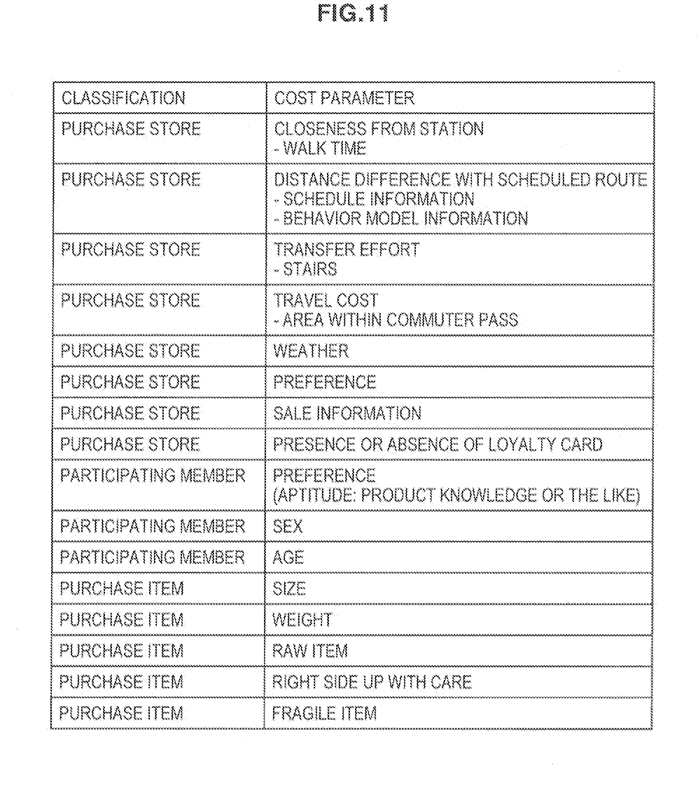

Next, the cost calculation for the purchase behavior in the shopping support server 10 according to an embodiment of the present disclosure will be described in detail with reference to FIGS. 10 and 11. FIG. 10 is a diagram illustrating the cost calculation of the shopping support server according to the embodiment. FIG. 11 is a table illustrating examples of parameters considered in the cost calculation of the shopping support server according to the embodiment.

As shown in FIG. 10, the value of the cost of a purchase behavior candidate is expressed by a sum of products of a plurality of cost parameters Attr and a weighting coefficient w of each parameter. Examples of the cost parameters of the purchase behavior candidate are shown in FIG. 11. As shown in FIG. 11, for example, the cost parameters may include a cost parameter regarding the characteristics of the purchase stores, a cost parameter regarding the characteristics of the participating members, and a cost parameter regarding the characteristics of the purchase items.

Examples of the cost parameter regarding the characteristics of a purchase store include closeness (walk time) from a station, a distance difference with a scheduled route, a transfer effort for going to the purchase store, a travel cost for going to the purchase store, the weather of that day, a preference for the purchase store, sale information, and presence or absence of a loyalty card. For example, since an unnecessary effect is made to go to a store remote from a station, the cost of the purchase behavior including this store may be set to be high. When a distance difference with the scheduled route in a case in which the purchase behavior is not executed is large, an unnecessary effort is made. Therefore, the cost of the purchase behavior including this store may be set to be high. When the participating member transfers from a mass transportation to another to go to the store, an unnecessary effort is made. At this time, when the participating member goes up and down stairs to transfer, an unnecessary effort is further made. Therefore, when the participating member transfers and also goes up and down stairs, the cost of the purchase behavior including the store may be set to be high. When the participating member uses a mass transportation in an area out of a commuter pass, an unnecessary travel cost occurs. Therefore, the cost of the purchase behavior including the store may be set to be high. When weather is bad, the cost of the purchase behavior in which a walk time is long may be set to be high. A preference of the task issuer or the participating member for a store may be reflected. For example, when a preferred store of the task issuer or the participating member is registered, the cost of the store may be set to be low. The cost of the store in the sale is preferably set to be low. When there is a store for which a loyalty card is owned by the task issuer or the participating member, the task issuer or the participating member may desire to use the specific store to accumulate points as far as possible. Therefore, when the store for which the loyalty card is owned by the task issuer or the participating member is registered, the cost of the store may be set to be low.

Examples of the cost parameters regarding the characteristics of the participating member include a preference, a sex, and an age. For example, a specific participating member may have an abundant knowledge of a given specific item. In this case, the cost of this item for the participating member may be set to be low. An item which can be easily purchased depending on a sex may be present. In this case, the cost of the item may be set to be low depending on the sex of the participating member. An item which may not be purchased depending on an age may be present. For example, minors are forbidden from purchasing cigarettes or alcohols. Therefore, the cost of such items is preferably set to be considerably high for minors.

The examples of the cost parameters regarding the characteristics of the purchase items include a size, a weight, whether the item is raw or not, whether the item can be transported upside down or not, and whether the item is fragile or not. For example, the cost may be set to be high for a large item. a heavy item, a raw stuff, an item that cannot be transported upside down, and a fragile item. The influence on the cost may be different depending on, for example, each participating member. For example, a large item, a heavy item, or the like may be set to be higher for a child than for an adult. The cost may be different depending on a transportation device which the participating member can select. For example, a large item or a heavy item is preferably undertaken when transportation by a private vehicle is possible. Further, the size and weight of an item to be carried are different between pedestrian movement and bicycle movement.

6. Determining Purchase Behavior

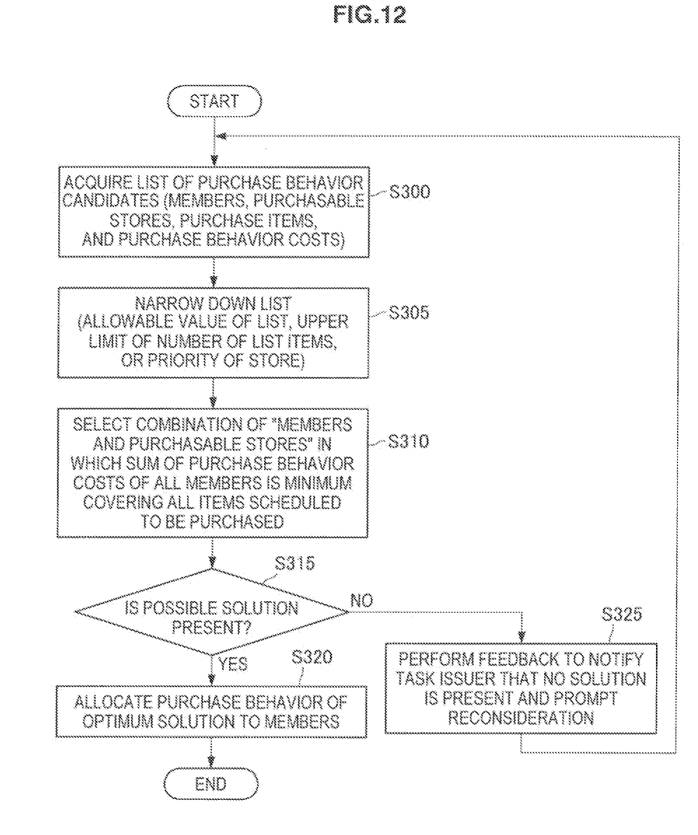

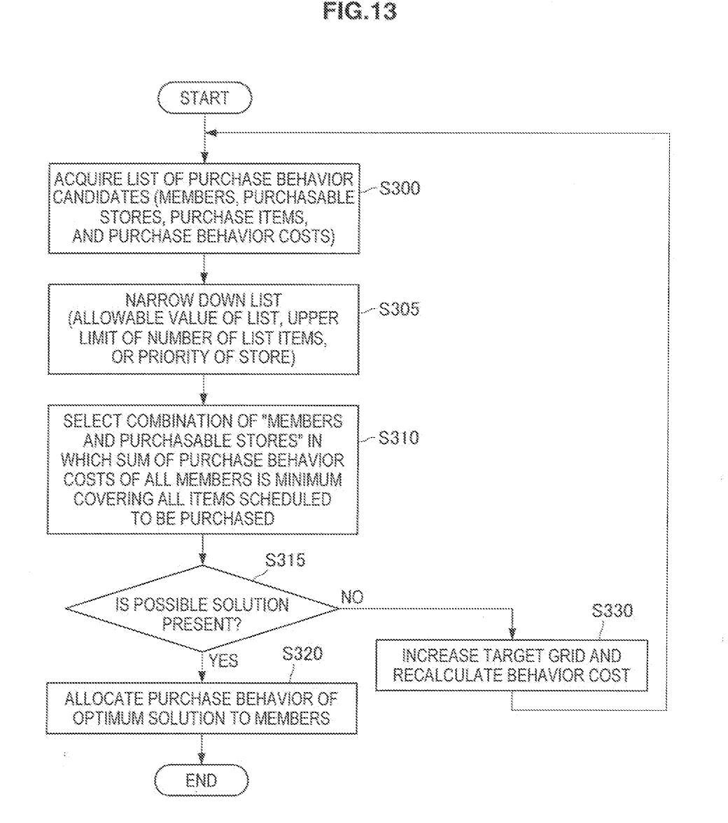

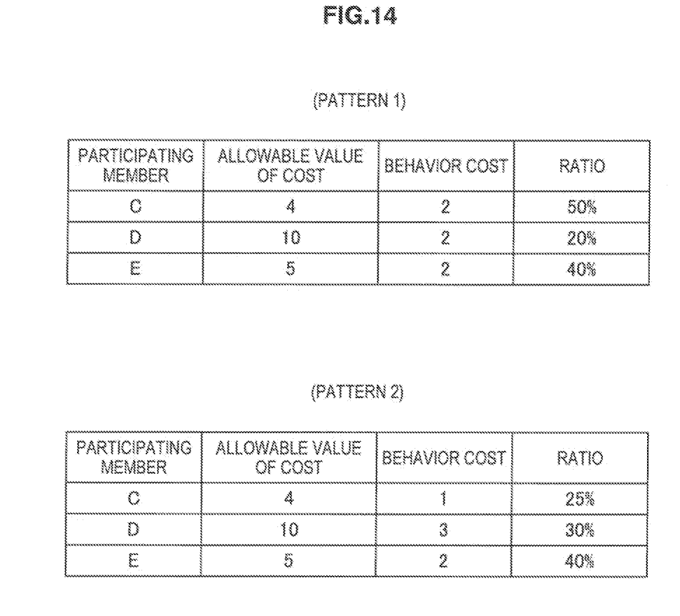

Next, the determination of the purchase behavior by the shopping support server 10 according to an embodiment of the present disclosure will be described with reference to FIGS. 12 to 14. FIG. 12 is a flowchart illustrating an example of a purchase behavior determination process of the shopping support server according to the embodiment. FIG. 13 is a flowchart illustrating another example of the purchase behavior determination process of the shopping support server according to the embodiment. FIG. 14 is a diagram illustrating the purchase behavior determination process of the shopping support server according to the embodiment.

Referring to FIG. 12, the allocation unit 120 first acquires a list of the purchase behavior candidates (S300). The acquired list of the purchase behavior candidates can include information regarding “the participating members, the purchasable stores, the purchase items, and the purchase behavior costs.”

Next, the allocation unit 120 narrows down the list of the purchase behavior candidates (S305). Here, the allocation unit 120 may narrow down the list of the purchase behavior candidates based on, for example, the allowable value of the cost of each participating member, the upper limit of the number of list items, or a priority of the store. For example, when the allowable value of the cost is set by the participating member, the purchase behavior candidate exceeding the allowable value may be removed from the list of the purchase behavior candidates. When the upper limit of the number of list items is determined, the purchase behavior candidate including the number of list items exceeding the upper limit may be removed from the list of the purchase behavior candidates. When the priority of the store is determined, the purchase behavior candidate including the store with low priority may be removed from the list of the purchase behavior candidates.

The allocation unit 120 selects a combination of the participating members and the purchase possibility stores in which the sum value of the purchase behavior costs of all the participating members is the minimum covering all of the items scheduled to be purchased (S310). Then, the allocation unit 120 determines whether a possible solution is present (S315). When the possible solution is present, the allocation unit 120 allocates the purchase behavior of an optimum solution to each participating member (S320). Conversely, when no possible solution is present in the determination of step S315, feedback is provided to notify the task issuer that no solution is present and reconsideration is suggested (S325).

In the process of step S310, the allocation unit 120 may allocate the purchase behavior by making an analysis as a problem of calculating the minimum weight (purchase behavior cost) in a collection of sets (purchase behaviors) covering all of the given component sets (sets of the purchase items). For example, a method of making an analysis as a set covering problem which is one of the representative combination optimization problems is considered.

When no possible solution is present in the process of FIG. 12, the allocation unit 120 prompts the task issuer to execute the reconsideration. However, the embodiment of the present disclosure is not limited to this example. For example, as shown in FIG. 13, a target grid for extracting the purchase store may be increased and the purchase behavior cost may be recalculated. For example, as described above, it is considered that the grid on the movement route is set as the target grid, but a grid adjacent to the grid on the movement route may be added. Thus, the purchase behavior candidates can be increased.

The allocation unit 120 may determine the purchase behavior, for example, based on a score for the allowable value of the purchase behavior cost of each participating member. At this time, the larger the score for the allowable value of the purchase behavior cost of each participating member is, the better the score is.

The allocation unit 120 may determine the purchase behavior based on the difference in “a ratio between the allowable value of the purchase behavior cost and the purchase behavior cost” between the members. At this time, the smaller the difference in “the ratio between the allowable value of the purchase behavior cost and the purchase behavior cost” between the members is, the better the difference is. For example, FIG. 14 shows two patterns, a pattern for the allowable values of the purchase behavior costs of the participating members and a pattern for “the ratio between the allowable value of the purchase behavior cost and the purchase behavior cost.” The allowable value of the cost of participating member C is 4, the allowable value of the cost of participating member D is 10, and the allowable value of the cost of participating member F is 5. At this time, in pattern 1 in which the purchase behavior costs are all 2, the ratios between the allowable values of the purchase behavior costs and the purchase behavior costs are 50% for participating member C, 20% for participating member D, and 40% for participating member E, In pattern 2, however, the purchase behavior cost of participating member C is 1, the purchase behavior cost of participating member D is 3, and the purchase behavior cost of participating member E is 2. At this time, the ratios of the allowable values of the purchase behavior costs and the purchase behavior costs are 25% for participating member C, 30% for participating member D, and 40% for participating member E. When pattern 1 is compared to pattern 2, the purchase behavior costs themselves in pattern 1 seem to be unfair. However, when the difference in the ratio between the allowable value of the purchase behavior cost and the purchase behavior cost is considered, the difference in the ratio between the allowable value of the purchase behavior cost and the purchase behavior cost is small in pattern 2, and thus purchase behavior costs can be considered to be fair.

7. Example of Hardware Configuration

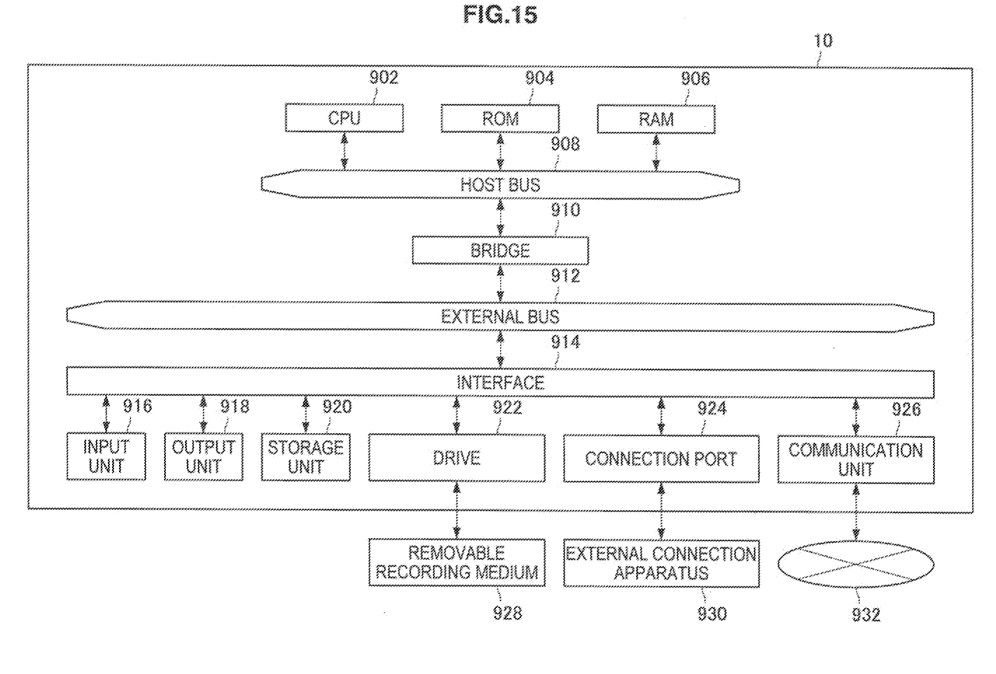

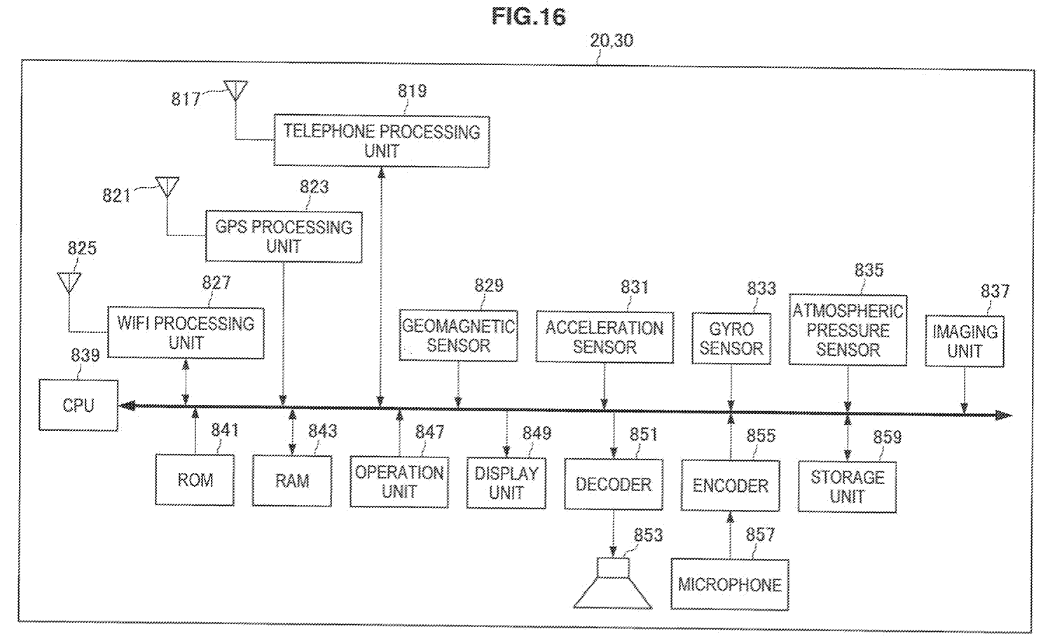

Next, examples of hardware configurations of the shopping support server 10, the requester terminal 20, and the member terminal 30 according to an embodiment of the present disclosure will be described with reference to FIGS. 15 and 16. FIG. 15 is a block diagram illustrating an example of a hardware configuration of the shopping support server according to the embodiment. FIG. 16 is a block diagram illustrating an example of a hardware configuration of the requester terminal and the member terminal according to the embodiment. Here case in which the shopping support server 10 is a server apparatus and the requester terminal 20 and the member terminal 30 are smart phones will be described. However, the embodiment of the present disclosure is not limited thereto. The functions of the shopping support server 10, the requester terminal 20, and the member terminal 30 may be realized by all kinds of information processing apparatuses. Further, the functions according to the embodiment of the present disclosure may be realized not only by a single information processing apparatus but also by a plurality of information processing apparatuses in a distributed processing manner.

Shopping Support Server 10

First, the function of each constituent element of the above-described shopping support server 10 can be realized, for example, using the hardware configuration shown in FIG. 15. That is, the function of each constituent element is realized causing a computer program to control the hardware shown in FIG. 15.

As shown in FIG. 15, the hardware mainly includes a CPU 902, a ROM 904, a RAM 906, a host bus 908, and a bridge 910. The hardware further includes an external bus 912, an interface 914, an input unit 916, an output unit 918, a storage unit 920, a drive 922, a connection port 924, and a communication unit 926. Here, “CPU” above is an abbreviation for “central processing unit” “ROM” above is an abbreviation for “read-only memory.” “RAM” above is an abbreviation for “random access memory.”

The CPU 902 functions as, for example, an arithmetic processing device or a control device and controls some or all of the processes of the constituent elements based on various programs recorded on the ROM 904, the RAM 906, the storage unit 920, or a removable recording medium 928. The ROM 904 is a unit that stores a program read by the CPU 902 or data or the like used for calculation. For example, the RAM 906 temporarily or permanently stores a program read by the CPU 902, or various parameters or the like appropriately changed when the program is executed.

For example, these constituent elements are connected to each other via the host bus 908 capable of transmitting data at a high speed. On the other hand, for example, the host bus 908 is connected to the external bus 912, which transmits data at a relatively low speed, via the bridge 910. A mouse. a keyboard, a touch panel, a. button, a switch, a lever, or the like is used as the input unit 916. Further, a remote controller capable of transmitting a control signal using infrared rays or other radio waves is used as the input unit 916 in some cases.

A display device such as a CRT, an LCD, a PDP, or an ELD, an audio output device such as a speaker or a headphone, a printer, a portable telephone, a facsimile device, or the like can be used as the output unit 918 capable of notifying users of acquired information in a visual or auditory way. “CRT” above is an abbreviation for “cathode ray tube.” “LCD” above is an abbreviation for “liquid crystal display.” “PDP” above is an abbreviation for “plasma display panel.” “ELD” above is an abbreviation “electro-luminescence display.”

The storage unit 920 is a device that stores various kinds of data. A magnetic storage device, such as an HDD, a semiconductor storage device, an optical storage device, a magneto-optical device, or the like is used as the storage unit 920. “HDD” above is an abbreviation for “hard disk drive.”

The drive 922 is a device that reads information recorded in the removable recording medium 928 such as a magnetic disk, an optical disc, a magneto-optical disc, or a semiconductor memory or writes information on the removable recording medium 928. Examples of the removable recording medium 928 include DVD media, Blu-ray media, HD DVD media, and various semiconductor storage media. Of course, examples of the removable recording medium 928 include IC cards on which a non-contact type IC chip is mounted or electronic apparatuses. “IC” above is an abbreviation for “integrated circuit.”

The connection port 924 is a port that is connected to an external connection device 930 such as a USB port, an IEEE 1394 port, an SCSI, an RS-232C port, or an optical audio terminal. Examples of the external connection device 930 include a printer, a portable music player, a digital camera, a digital video camera, and an IC recorder. “USB” above is an abbreviation for “universal serial bus.” “SCSI” above is an abbreviation for “small computer system interface.”

The communication unit 926 is a communication device that is connected to a network 932. Examples of the communication unit 926 include a wired or wireless LAN, Bluetooth (registered trademark), a WUSB communication card, an optical communication router, an ADSL router, and various communication modems. Further, the network 932 connected to the communication unit 926 is configured by networks connected to each other in wired or wireless ways. The examples of the network 932 include the Internet, a household LAN, infrared communication, visible communication, broadcasting, and satellite communication. “LAN” above is an abbreviation for “local area network.” “WUSB” above is an abbreviation for “wireless USB.” “ADSL” above is an abbreviation for “asymmetric digital subscriber line.”

Requester Terminal 20 and Member Terminal 30

Next, an example of a hardware configuration of the requester terminal 20 and the member terminal 30 according to an embodiment of the present disclosure will be described with reference to FIG. 16. FIG. 16 is a block diagram illustrating the hardware configuration of the requester terminal and the member terminal according to the embodiment.

Hereinafter, an example of the configuration of the requester terminal 20 and the member terminal 30 will be described. Referring to FIG. 16, the requester terminal 20 and the member terminal 30 each include a telephone network antenna 817, a telephone processing unit 819, a GPS antenna 821, a GPS processing unit 823, a Wi-Fi antenna 825, a Wi-Fi processing unit 827, a geomagnetic sensor 829, an acceleration sensor 831, a gyro sensor 833, an atmospheric pressure sensor 835, an imaging unit 837, a CPU 839, a ROM 841, a RAM 843, an operation unit 847, a display unit 849, a decoder 851, a speaker 853, an encoder 855, a microphone 857, and a storage unit 859. The hardware configuration mentioned here is merely an example and some of the constituent elements may not be used. Further, constituent elements other than the constituent elements mentioned here may, of course, be added.

Telephone Network Antenna 817

The telephone network antenna 817 is an example of an antenna that has a function of performing wireless connection with a portable telephone network for telephony and communication. The telephone network antenna 817 can supply a telephone signal received via the portable telephone network to the telephone processing unit 819.

Telephone Processing Unit 819

The telephone processing unit 819 has a function of performing various kinds of signal processing on signals transmitted and received through the telephone network antenna 817. The telephone processing unit 819 can perform various kinds of signal processing on a sound signal input through, for example, the microphone 857 and encoded by the encoder 855 and supply the processed sound signal to the telephone network antenna 817. Further, the telephone processing unit 819 can perform various kinds of signal processing on the sound signal supplied from the telephone network antenna 817 and supply the processed sound signal to the decoder 851.

GPS Antenna 821

The GPS antenna 821 is an example of an antenna that receives a signal from a positioning satellite. Since the GPS antenna 821 is able to receive GPS signals from a plurality of GPS satellites, the GPS antenna 821 inputs the received GPS signals to the GPS processing unit 823.

GPS Processing Unit 823

The GPS processing unit 823 is an example of a calculation unit that calculates position information based on a signal received from a positioning satellite. The GPS processing unit 823 calculates the current position information based on the plurality of GPS signals input from the GPS antenna 821 and outputs the calculated position information. Specifically, the GPS processing unit 823 calculates the position of each GPS satellite based on orbit data of each GPS satellite and calculates the distances between each GPS satellite, and the requester terminal 20 and the member terminal 30 based on a time difference between the transmission time and the reception time of the GPS signal. Then, the GPS processing unit 823 can calculate the current three-dimensional position based on the calculated position of each GPS satellite and the calculated distances between each GPS satellite, and the requester terminal 20 and the member terminal 30. The orbit data of the GPS satellite used here may be included in, for example, the GPS signal. Alternatively, the orbit data of the GPS satellite may be acquired from an external server via the communication antenna 825.

Wi-Fi Antenna 825

The Wi-Fi antenna 825 is an antenna that has a function of transmitting and receiving a communication signal to and from, for example, a wireless local area network (LAN) communication network in accordance with the specification of Wi-Fi. The Wi-Fi antenna 825 can supply the received signal to the Wi-Fi processing unit 827.

Wi-Fi Processing Unit 827

The Wi-Fi processing unit 827 has a function of performing various kinds of signal processing on the signal supplied from the Wi-Fi antenna 825. The Wi-Fi processing unit 827 can supply a digital signal generated from a supplied analog signal to the CPU 839.

Geomagnetic Sensor 829

The geomagnetic sensor 829 is a sensor that detects geomagnetism as a voltage value. The geomagnetic sensor 829 may be a triaxial geomagnetic sensor that detects geomagnetism in the X-axis direction, the Y-axis direction, and the Z-axis direction. The geomagnetic sensor 829 can supply the detected geomagnetism data to the CPU 839.

Acceleration Sensor 831

The acceleration sensor 831 is a sensor that detects acceleration as a voltage: value. The acceleration sensor 831 may be a triaxial acceleration sensor that detects each of the acceleration in the X-axis direction, the acceleration in the Y-axis direction, and the acceleration in the Z-axis direction. The acceleration sensor 831 can supply the detected acceleration data to the CPU 839.

Gyro Sensor 833

The gyro sensor 833 is a kind of measurer that detects an angle or angular velocity of an object, The gyro sensor 833 may be a triaxial gyro sensor that detects speeds (angular velocities) at which rotational angles change about the X axis, the Y axis, and the 1 axis. The gyro sensor 833 can supply the detected angular velocity data to the CPU 839.

Atmospheric Pressure Sensor 835

The atmospheric pressure sensor 835 is a. sensor that detects a surrounding atmospheric pressure as a voltage value. The atmospheric pressure sensor 835 can detect an atmospheric pressure as a predetermined sampling frequency and supply the detected atmospheric pressure data to the CPU 839.

Imaging Unit 837

The imaging unit 837 has a function of photographing a still image or a video via a lens under the control of the CPU 839. The imaging unit 837 may store a photographed image in the storage unit 859.

CPU 839

The CPU 839 functions as an arithmetic processing device or a control device and controls general operations of a portable terminal 30 in accordance with various programs. The CPU 839 may be a microprocessor. The CPU 839 can realize various functions in accordance with various programs.

ROM 841 and RAM 843

The ROM 841 can store programs, calculation parameters, or the like to be used by the CPU 839. The RAM 843 can temporarily store programs to be used through execution of the CPU 839 or parameters or the like appropriately changed in the execution.

Operation Unit 847

The operation unit 847 has a function of generating an input signal used for a user 5 to perform a desired operation. The operation unit 847 may include an input unit, such as a touch sensor, a mouse, a keyboard, a button, a microphone, a switch, or a lever, which is used when the user 5 inputs information and an input control circuit that generates an input signal in response to an input operation of the user 5 and outputs the input signal to the CPU 839.

Display Unit 849

The display unit 849 is an example of an output device. The display unit 849 may be a display device such as a liquid crystal display (LCD) device or an organic light emitting diode ((MED) display device. The display unit 849 can supply information by displaying a screen for the user 5.

Decoder 851 and Speaker 853

The decoder 851 has a function of decoding input data and performing analog conversion or the like under the control of the CPU 839. The decoder 851 can perform decoding, analog conversion, or the like on sound data input via, for example, the telephone network antenna 817 and the telephone processing unit 819, and then output the processed sound signal to the speaker 853. The decoder 851 can perform decoding, analog conversion, or the like on sound data input via, for example, the Wi-Fi antenna 825 and the Wi-Fi processing unit 827, and then output the processed sound signal to the speaker 853. The speaker 853 can output sound based on the sound signal supplied from the decoder 851.

Encoder 855 and Microphone 857

The encoder 855 has a function of performing digital conversion, encoding, or the like on input data under the control of the CPU 839. The encoder 855 can perform digital conversion, encoding, or the like on a sound signal input from the microphone 857, and then output the sound data. The microphone 857 can collect sound and output the sound as a sound signal,

Storage Unit 859

The storage unit 859 is a device that stores data and may include a storage medium, a recording device that records the data on the storage medium, a device that reads the data from the storage medium, and a deletion device that deletes the data recorded on the storage medium. Examples of the storage medium include a non-volatile memory such as a flash memory, a magnetoresistive random access memory (MRAM), a ferroelectric random access memory (FeRAM), a phase change random access memory (PRAM), or an electronically erasable and programmable read-only memory (EEPROM), and a magnetic recording medium such as a hard disk drive (HDD).

It should be understood by those skilled in the art that various modifications, combinations, sub-combinations and alterations may occur depending on design requirements and other factors insofar as they are within the scope of the appended claims or the equivalents thereof.

In the specification, the steps described in the flowcharts include the steps that are, of course, processed chronologically in the described order and the steps and include the steps that are processed in parallel or separately, although not necessarily processed chronologically. Of course, the order of the steps that are chronologically processed may be modified appropriately, as necessary.

Additionally, the present technology may also be configured as below.
(1) An information processing apparatus including:
   a condition acquisition that acquires a task condition of a shopping task;
   a cost calculation unit that calculates a cost of a candidate of a purchase behavior for executing the shopping task by a participating member participating in the shopping task based on a characteristic of an item purchased through the purchase behavior; and
   a determination unit that determines the purchase behavior of the participating member based on the cost.
(2) The information processing apparatus according to (1), wherein the cost calculation unit calculates the cost further based on a characteristic of the participating member,
(3) The information processing apparatus according to (2), wherein the cost calculation unit calculates the cost based on preference information of the participating member.
(4) The information processing apparatus according to any one of (1) to (3), wherein the determination unit determines the purchase behavior based on an allowable value of the cost for each participating member,
(5) The information processing apparatus according to (4), wherein the determination unit determines the purchase behavior such that a difference in a ratio between the allowable value and the cost decreases between the participating members.
(6) The information processing apparatus according to any one of (1) to (4), wherein the determination unit determines the purchase behavior such that a sum value of the cost of each participating member decreases.
(7) The information processing apparatus according to any one of (1) to (6), wherein the candidate of the purchase behavior is specified by combination of the participating member executing the purchase behavior, a. purchase store at which the item is purchased, and the item.
(8) The information processing apparatus according to any one of (1) to (7), further including:
   a notification unit that notifies the participating member of the purchase behavior determined by the determination unit.
(9) The information processing apparatus according to (8), wherein a first notification screen on which the notification unit performs notification of the purchase behavior includes a first feedback portion in which the participating member responds to whether to accept the execution of the purchase behavior.
(10) The information processing apparatus according to (9),
   wherein the notification unit provides a second notification screen on which the notification unit performs notification of information on a plurality of the purchase behaviors, and
   wherein the second notification screen includes a second feedback portion in which the participating member gives a notification of a progress status of the purchase behavior.
(11) The information processing apparatus according to (10), further including:
   a feedback control unit that updates the task condition based on the notification of the progress status given via the second feedback portion.
(12) An information processing method including:
   acquiring a task condition of a shopping task;
   calculating a. cost of a candidate of a purchase behavior for executing the shopping task by a participating member participating in the shopping task based on a characteristic of an item purchased through the purchase behavior; and
   determining the purchase behavior of the participating member based on the cost.
(13) A program for causing a computer to function as an information processing apparatus including:
   a condition acquisition unit that acquires a task condition of a shopping task;
   a cost calculation unit that calculates a cost of a candidate of a purchase behavior for executing the shopping task by a participating member participating in the shopping task based on a characteristic of an item purchased through the purchase behavior; and
   a determination unit that determines the purchase behavior of the participating member based on the cost.

The present disclosure contains subject matter related to that disclosed in Japanese Priority Patent Application JP 2011-260433 filed in the Japan Patent Office on Nov. 29, 2011, the entire content of which is hereby incorporated by reference.

What is claimed is:

1. An information processing apparatus comprising:
a condition acquisition unit that acquires a task condition of a shopping task;
a cost calculation unit that calculates a cost of a candidate of a purchase behavior for executing the shopping task by a participating member participating in the shopping task based on a characteristic of an item purchased through the purchase behavior; and
a determination unit that determines the purchase behavior of the participating member based on the cost.

2. The information processing apparatus according to claim 1, wherein the cost calculation unit calculates the cost further based on a characteristic of the participating member.

3. The information processing apparatus according to claim 2, wherein the cost calculation unit calculates the cost based on preference information of the participating member.

4. The information processing apparatus according to claim 1, wherein the determination unit determines the purchase behavior based on an allowable value of the cost for each participating member.

5. The information processing apparatus according to claim 4, wherein the determination unit determines the purchase behavior such that a difference in a ratio between the allowable value and the cost decreases between the participating members.

6. The information processing apparatus according to claim 1, wherein the determination unit determines the purchase behavior such that a sum value of the cost of each participating member decreases.

7. The information processing apparatus according to claim 1, wherein the candidate of the purchase behavior is specified by combination of the participating member executing the purchase behavior, a purchase store at which the item is purchased, and the item.

8. The information processing apparatus according to claim 1, further comprising:
a notification unit that notifies the participating member of the purchase behavior determined by the determination unit.

9. The information processing apparatus according to claim 8, wherein a first notification screen on which the notification unit performs notification of the purchase behavior includes a first feedback portion in which the participating member responds to whether to accept the execution of the purchase behavior.

10. The information processing apparatus according to claim 9,
wherein the notification unit provides a second notification screen on which the notification unit performs notification of information on a plurality of the purchase behaviors, and
wherein the second notification screen includes a second feedback portion in which the participating member gives a notification of a progress status of the purchase behavior.

11. The information processing apparatus according to claim 10, further comprising:
a feedback control unit that updates the task condition based on the notification of the progress status given via the second feedback portion.

12. An information processing method comprising:
acquiring a task condition of a shopping task;
calculating a cost of a candidate of a purchase behavior for executing the shopping task by a participating member participating in the shopping task based on a characteristic of an item purchased through the purchase behavior; and
determining the purchase behavior of the participating member based on the cost.

13. A program for causing a computer to function as an information processing apparatus including:
a condition acquisition unit that acquires a task condition of a shopping task;
a cost calculation unit that calculates a cost of a candidate of a purchase behavior for executing the shopping task by a participating member participating in the shopping task based on a characteristic of an item purchased through the purchase behavior; and
a determination unit that determines the purchase behavior of the participating member based on the cost.
